(19) United States
(12) Patent Application Publication
(10) Pub. No.: US 2003/0152414 A1
(43) Pub. Date: Aug. 14, 2003

(54) Apparatus for spreading liquid materials

(76) Inventor: Kyung-Jin Yu, Seoul (KR)

Correspondence Address: SHERIDAN ROSS PC, 1560 BROADWAY, SUITE 1200, DENVER, CO, 80202

(21) Appl. No.: 10/332,484

(22) PCT Filed: Jul. 9, 2001
(86) PCT No.: PCT/KR01/01174

(30) Foreign Application Priority Data
Jul. 8, 2000 (KR) 2000-39173
Aug. 3, 2000 (KR) 2000-22184U
Dec. 12, 2000 (KR) 2000-34849U
Mar. 28, 2001 (KR) 2001-8684U

(51) Int. Cl. B43K 5/00

(52) U.S. Cl. 401/205; 401/202; 401/183

(57) ABSTRACT

An apparatus for spreading liquid materials comprises: a provision unit for providing the liquid material; a guiding unit, coupled to the provision unit, for providing a flow path of the liquid materials; and an absorption unit, covering one portion of the guiding unit, for absorbing the liquid materials supplied from the guiding unit and applying the liquid materials to a designated region of a body.

### DESCRIPTION

1. Technical Field

The present invention relates to an apparatus for spreading a liquid material; and, more particularly, to an apparatus for spreading liquid-type medicine moderately while preventing it from running down.

2. Background Art

Generally, a disinfectant or a mucous liniment is used to treat inflammation between the toes, between the fingers, between the teeth and the gum, and inside the ear of a human being or a pet. To sterilize the wounded part, a moderate amount of sanitary cotton or a cotton-tip stick is dipped in the disinfectant or liniment and applied to the wounded part. But when the liquid material is overly absorbed while dipping the cotton in the disinfectant or liniment, it may drip onto the floor or run down from the wounded part due to the excessive amount of the liniment applied thereto, so there is uncomfortableness that people have to wipe out the run-down liniment or the liniment applied out of the wounded zone after the treatment. Also, in case of using a cotton-tip stick, there is a problem that the liniment may not be obtained enough and thus hinder proper disinfection or treatment because the cotton could be wound up too tightly on the tip, or because the amount of the cotton is provided too little.

Pet animals including a pet dog have sticky excreta secreted in the ears, emitting bad smell and being a home for bacterium propagation. So, their ears need to be cleaned often. A human being may develop inflammation inside the ear. The conventional treatment for this includes dropping liniment in the ears and makes it spread widely on the internal surface of them by inserting a cotton-tip stick, or directly dipping a cotton-tip stick into the liniment and inserting and applying it in the ear. But there is a problem that the liniment cannot be applied at a moderate amount. Also the liquid into the ear may run outside when the liniment is inputted excessively. Moreover, there is a danger the external ear road or the eardrum may be damaged, for it's hard to estimate how deeply to insert the cotton-tip stick.

Meanwhile, to clean the inside of the mouth, one brushes his teeth and tongue with a tooth brush and paste, or just simply keeps a liquid oral cleaner (gargling solution) in the mouth, gargling and putting it out.

The former method brushing the teeth with a tooth brush and paste has inconvenience that one has to spend a predetermined time dedicated to it, and there is a limitation that he should brush his teeth at regular places such as home or workplace. In addition, depending on the way of brushing, there is another problem that the gum may be hurt when he has an improper brushing habit such as brushing teeth left to right only, not sweeping them up and down. The latter method using an oral cleaner, however, solves these problems by just keeping the gargling solution in the mouth, gargling and putting it out. It is very convenient to use. It can keep your mouth clean wherever you are. However, it also carries some shortcomings that it's hard to remove dregs stuck between the teeth, and that the teeth and the gum get less cleaned than in the method using a toothbrush. Moreover, just gargling the mouth, it gives less of freshness to the user and the amount of the solution used for one serving is rather much.

### DISCLOSURE OF INVENTION

It is, therefore, an object of the present invention to provide a liniment spreading apparatus for spreading liquid material to a certain part of a body easily and conveniently by integrating a container holding a disinfectant or mucous liniment and a liquid absorption pad, the apparatus that can provide the liniment continuously but makes the liquid absorption pad contain only a moderate amount of the liniment so as not to run down.

It is another object of the present invention to provide a liniment spreading apparatus can be mass-produced by combining the liquid container and the liniment inducing pipe reliably, and by molding them through the method of injection molding.

It is further another object of the present invention to provide a liniment spreading apparatus that can treat or clean the inside of the ear safely without inflicting any damage on its external ear road or eardrum by making the apparatus inserted to a predetermined depth.

It is still another object of the present invention to provide a liniment spreading apparatus that does not cause any harm to the environment by manufacturing the disposable liquid absorption pad with an environment-friendly material.

In accordance with one aspect of the present invention, there is provided a liniment spreading apparatus, comprising: a liniment provision means; a liniment inducing means linked to the liniment provision means, for providing a flow path of a liniment; and a liniment absorption means wrapping one end of the liniment inducing means for absorbing the liniment discharged therefrom and applying it to a certain part of a body.

### BRIEF DESCRIPTION OF DRAWINGS

The above and other objects and features of the present invention will become apparent from the following description of the preferred embodiments given in conjunction with the accompanying drawings, in which:

FIG. 1 illustrates a disassembled perspective view of a liniment spreading apparatus in accordance with an embodiment of the present invention;

FIG. 2 shows a cross-sectional view of the assembled liniment spreading apparatus in accordance with the present invention;

FIG. 3 depicts a perspective view of the liniment inducing pipe of the present invention;

FIG. 4 is a cross-sectional view of the joint block in accordance with another embodiment of the present;

FIG. 5 shows a perspective view of a liniment inducing pipe in accordance with another embodiment of the present;

FIG. 6 illustrates a disassembled perspective view of the liniment spreading apparatus in accordance with another embodiment of the present;

FIG. 7 is a cross-sectional view depicting the connection between the liniment inducing pipe and the liniment absorption pad of FIG. 6;

FIG. 8 shows a perspective view of the liniment inducing pipe of FIG. 6;

FIG. 9 is a perspective view of the liniment absorption pad in accordance with another embodiment of the present invention;

FIG. 10 is a cross-sectional view of the liniment absorption pad of FIG. 9;

FIG. 11 depicts a perspective view of the liniment absorption pad in accordance with yet another embodiment of the present invention;

FIG. 12 represents a perspective view of a clean pad of the present invention;

FIG. 13 is a cross-sectional view of the clean pad of FIG. 12;

FIG. 14 is a disassembled perspective view illustrating a liniment spreading apparatus in accordance with yet another embodiment of the present invention;

FIG. 15 is a cross-sectional view of the assembled liniment spreading apparatus of FIG. 14;

FIG. 16 is a disassembled perspective view depicting an oral cleaner in accordance with an embodiment of the present invention;

FIG. 17 is a disassembled perspective view showing an order cleaner in accordance with another embodiment of the present invention; and

FIG. 18 is a perspective view of the clean pad without the absorption pad in accordance with the invention.

### BEST MODE FOR CARRYING OUT THE INVENTION

Other objects and aspects of the invention will become apparent from the following description of the embodiments with reference to the accompanying drawings, which is set forth hereinafter.

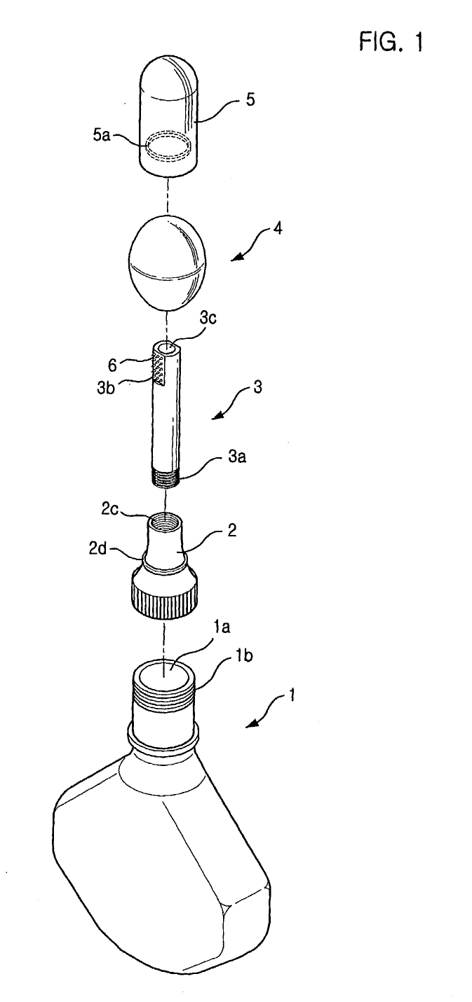

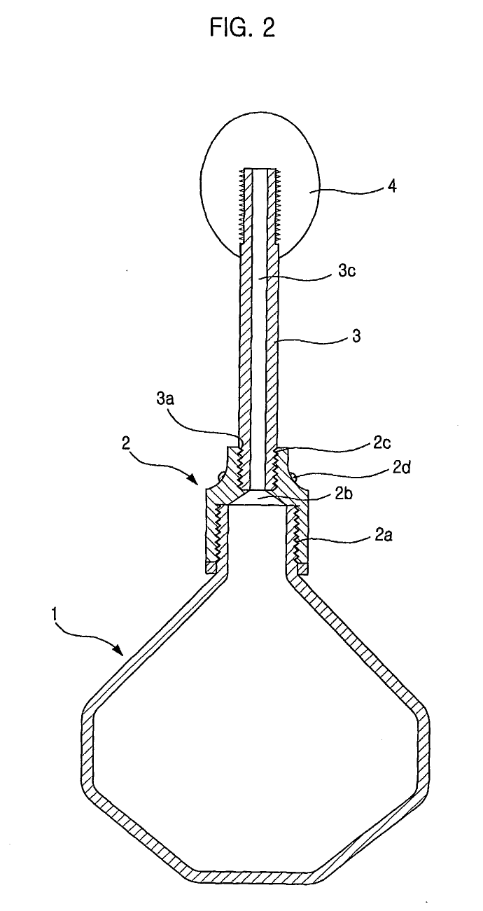

FIG. 1 illustrates a disassembled perspective view of a liniment spreading apparatus in accordance with an embodiment of the present invention, and FIG. 2 is its cross-sectional view.

As illustrated in FIGS. 1 and 2, the liniment spread apparatus comprises a container 1 for containing liquid material; a liniment inducing pipe 3 which is shaped like a pipeline 3C penetrating along the length for providing a flow path of the liniment coming out of the opening of the container; a liniment absorption pad 4 linked to the liniment inducing pipe 3 for absorbing the liquid material from it and spreading the liniment on a certain part of a body; a joint block 2 for connecting the container and the liniment inducing pipe; and a cover 5 for closing the opening of the container when the liniment inducing pipe and the liniment absorbsion pad are removed, the liniment inducing pipe and the liniment absorbsion pad being made of a disposable material.

The container 1 is provided with a first male screw part 1B on the external circumferential surface of the opening 1A, and it contains a disinfectant or mucous liniment.

The joint block 2 includes a first female screw part 2A on the internal circumferential surface of one end corresponding to the first male screw part 1B of the container 1 to be connected; a second female screw part 2C on the internal circumferential surface of the other end; an undercut 2D on the external circumferential surface; a penetrating hole 2B for discharging the liniment from the opening 1A of the container 1.

The liniment inducing pipe 3 includes a second male screw part 3A on the external circumferential surface of one end to be connected to the second female screw part 2C of the joint block 2; a plurality of fixed bosses 3B formed in a predetermined length on the other end; a hollow pipeline 3C penetrating along the length, the liniment inducing pipe formed in the shape of a penetrating hollow pipeline 3C for providing a flow path of the liniment.

Here, the thickness between the external surface of the other end of the liniment inducing pipe 3 and the pipeline 3C is incised predetermined long in the length direction, thus forming flat surface 6, and a plurality of fixed bosses 3B are formed on that flat surface 6. In FIG. 1, the structure is formed with two flat surfaces facing to each other.

In this embodiment, the fixed bosses 3B formed on the flat surface 6 of the liniment inducing pipe 3 formed like thorns. However, other shapes of embossing are possible and they are for holding the liniment absorption pad 4 firmly when the pad is wrapped.

Also, the joint block 2 and the liniment inducing pipe 3 are connected in a structure linked with screws. Besides, they can be connected in the insert-and-fix structure by forming an underline (now shown) on one end of one of them and an undercut (now shown) on the other.

The liniment absorption pad 4 wraps around the fixed boss 3B part of the liniment inducing pipe 3 firmly with an adhesive material, absorbs the liniment coming out through the pipeline 3C of the liniment inducing pipe 3, and spreads the liquid material on a certain part of a body.

The cover 5 is molded with an underline 5A on the internal circumferential surface to be linked to the undercut 2D of the joint block 2. It is used to seal the joint block 2 tightly to keep the liquid in the container 1 when the liniment inducing pipe 3 is removed from the joint block 2.

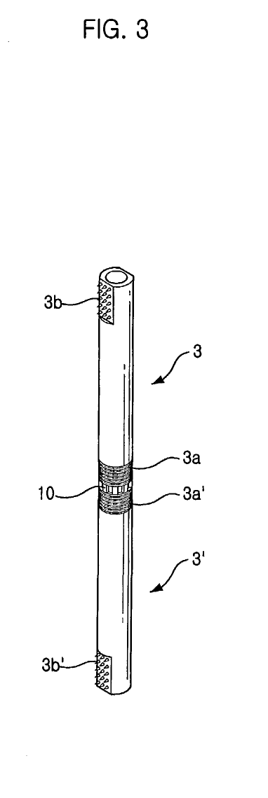

FIG. 3 depicts a perspective view of the liniment inducing pipe of the present invention. In this drawing, one end of the liniment inducing pipe 3 is formed with a male screw 3A or an undercut (or underline), the other end formed with a plurality of thorn bosses 3B on a flat surface 6. Two liniment inducing pipes are manufactured coupled to each other as a piece. That is, they can be mass-produced in the injection molding method by forming flat surfaces on predetermined spots of both ends of the pipes 3, 3′ of a predetermined length with a plurality of thorn bosses 3B, 3B′, forming male screws 3A, 3A′ (or undercuts) on predetermined spots of both ends with a line at center, and forming cut-off surface 10 on that central line.

The liniment inducing pipe 3 is made of a disposable material such as general plastics, e.g., polyethylene (PE) and polypropylene (PP) in the injection molding method. Not being limited to these materials, of course, they can be manufactured with other environment-friendly materials. That is, they can be made of any one of the materials like gelatin, which is used as a material for the capsule of general medicines, for instance, an antibiotic medicine, or flour with high resolvability that contains the enzyme amylase for heightening the stability of emulsification, durum semolina, starch, condorax, or special-quality paper material coated with a water-repellent chemicals. They are manufactured by adding a catalyst, melamine, etc., to the above flour, providing starch solution into a single or double drum drying machine, drying it to the state of film and pulverizing as soon as boiling and swelling it at high temperature, usually 130-180° C.

Accordingly, being made of one of the materials above, the liniment inducing pipe 3 will be decomposed after the use and cope with the environment problem appropriately.

The liniment absorption pad 4 is fixed with an adhesive material when it is wrapped on the thorn bosses 3B of the liniment inducing pipe 3. It uses cotton to absorb and hold the liquid sufficiently. Usually, sanitary cotton that absorbs liniment fast is desirable.

In this embodiment, to make the liniment absorption pad stuck to the external circumferential surface of the liniment inducing pipe at a certain adherence, a adhesive material is used on the liniment absorption pad 4 to control the surfaces of soft material and hard material. For instance, among the adhesive material that can be used are unharmful materials to a human body such as CMC (Carboxyl Methyl Cellulose), EVA (Ethylene-Vinyl Acetate Copolymer), melamine, gelatin, polyethylene, hydro-propyl cellulose, ethylene acid bicopolymer, and dextrin. Mixing a catalyst or a hardening agent to the adhesive material in a predetermined ratio, the surface hardness of the liniment absorption pad can be controlled. Moreover, adding a germicidal agent and antibiotic material to the mixture, the liniment absorption pad can be connected with the liniment inducing pipe hygienically.

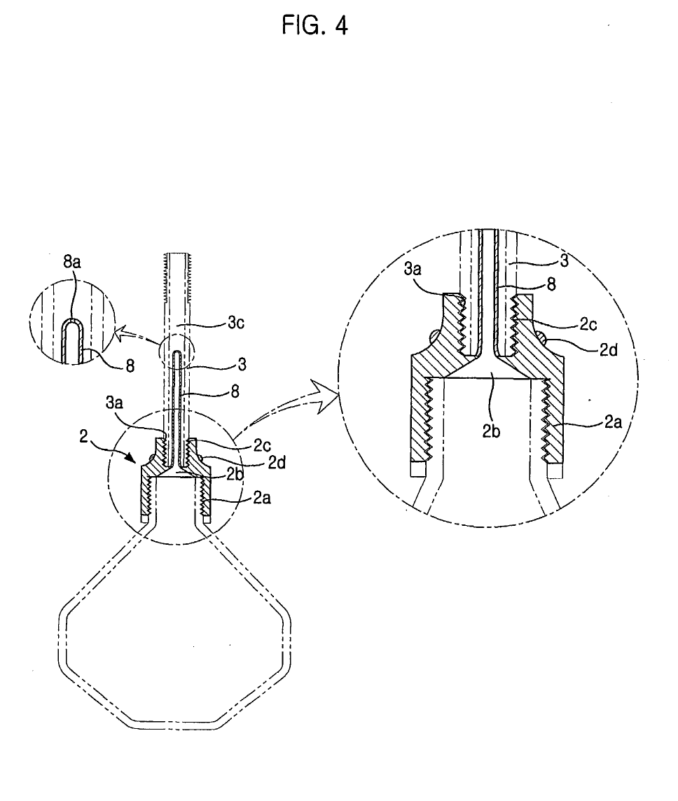

FIG. 4 is a cross-sectional view showing the joint block in accordance with another embodiment of the present.

As shown in the drawing, a predetermined length of a midway pipeline 8 is formed protruded towards the second female screw part 2C from the penetrating hole 2B of the joint block 2. That is, the illustrated midway pipeline 8 has a long protrusion outside the second female screw part 2C and a ejection hole 8A is formed at the tip of it. Here, the midway pipeline 8 is formed to be inserted to the pipeline 3C of the liniment inducing pipe 3, thus making firm the binding of the second female screw part 2C and the second male screw part 3A as well as preventing leakage of the liniment through where the joint block 2 and the liniment inducing pipe 3 are connected while discharging it.

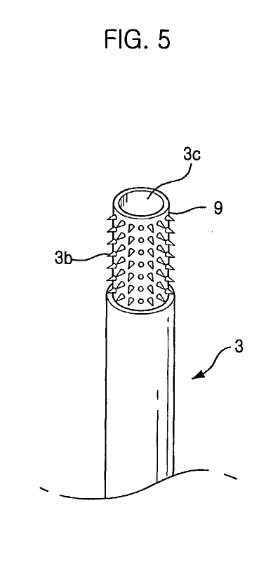

FIG. 5 shows a perspective view of a liniment inducing pipe in accordance with another embodiment of the present.

As illustrated in FIG. 5, the liquid material can be absorbed faster throughout the liniment absorption pad 4 by forming a number of ejection holes 9 between the thorn bosses 3B of the liniment inducing pipe 3.

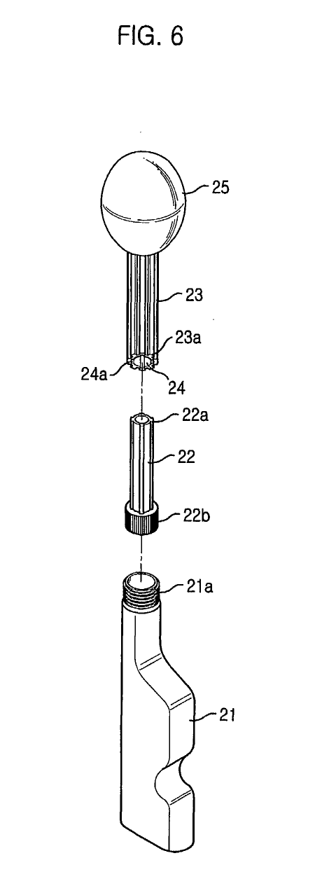

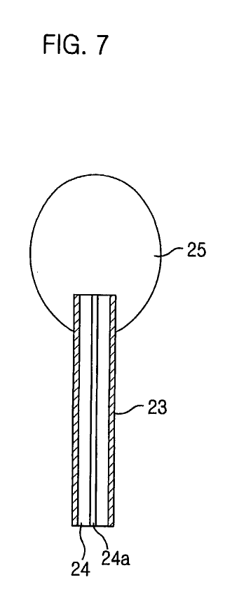

FIG. 6 illustrates a disassembled perspective view of the liniment spreading apparatus in accordance with another embodiment of the present, and FIG. 7 is a cross-sectional view depicting the connection between the liniment inducing pipe and the liniment absorption pad of FIG. 6.

Referring to FIG. 6, the container 21 is formed with a male screw part 21A on the external circumferential surface of the opening and contains liquid inside.

The joint block 22 which is linked to the opening of the container 21 for providing liniment outside is formed with at least one fixed protrusion 22A along the length on the external circumferential surface, and a female screw pipe 22B to be linked to the male screw part 21A of the container 21 at the lower part.

The liniment inducing pipe 23 includes guiding grooves 24A formed along the length of the internal surface of the pipeline, the guiding grooves corresponding to, the fixed protrusion 22A of the joint block 22. On the external circumferential surface a plurality of fixed protrusions 23A are molded creasingly.

Here, the fixed protrusions 23A on the external circumferential surface of the liniment inducing pipe 23 are molded angularly, and the present invention shows an embodiment with octagonal protrusions. The four guiding grooves 24A formed on the internal surface of the liniment inducing pipe 23 at a regular distance are made to be linked to the regular protrusions 22A of the joint block 22 in the method of insert-and-fix. Being produced in the injection molding method to have this structure, the liniment inducing pipe 23 can be manufactured in mass.

This embodiment shows an exemplary structure, in which the liquid material can be sent out through the pipeline of the liniment inducing pipe 23 alone, but this invention is not limited to the structure, but a plurality of ejection holes (not shown) can be formed on the external circumferential surface of one end of the liniment inducing pipe 23 to discharge the liniment outside. In this case, the liniment can be absorbed in the liniment absorption pad 25 faster.

The liniment absorption pad 25 wraps the external circumferential surface of one end of the liniment inducing pipe 23, absorbs the liquid material ejected through the pipeline 24, and spreads it on a certain part of a body.

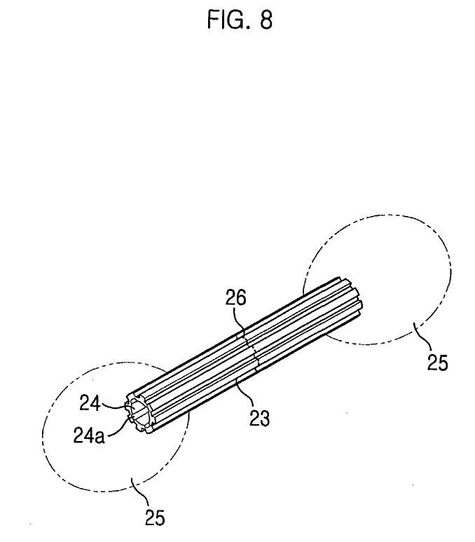

FIG. 8 shows a perspective view of the liniment inducing pipe of FIG. 6.

The liniment inducing pipe 23 is produced in injection molding method and can be manufactured in mass. Also, as illustrated in FIG. 8, molding a cut-off surface 26 on a predetermined part of the liniment inducing pipe 23 and liniment absorption pads 25, the mass-productivity of the present invention has been increased. In addition, the material for the liniment inducing pipe 23, adhesive material for attaching the liniment absorption pad 25 to it, catalyst or hardening agent added to control the surface hardness of the liniment absorption pad 25, and the germicidal agent and the antibiotic material and the mixing ratio of them can be the same as those of the embodiment described previously. In other words, they can be embodied the same as those represented in FIG. 3.

The structure of the liniment absorption pad 25 can be molded differently according to the usage. When spreading liniment widely on a part of a body, it is formed with uncompressed cotton wrapped thereto over and over as illustrated in FIGS. 6 and 7.

On the other hand, when using it to clean the mouth or the ear, the liniment absorption pad is made compressed at a predetermined hardness.

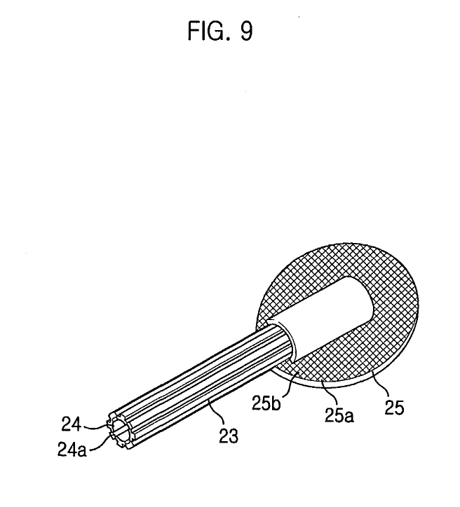

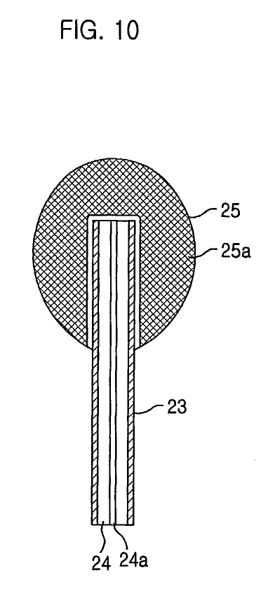

As depicted in FIGS. 9 and 10, the liniment absorption pad 25 is compressed and hardened to have a predetermined width of the external circumference. It is desirable to make embossing on the hardened surface 25A of the liniment absorption pad 25. Then it can be used as an oral cleaner.

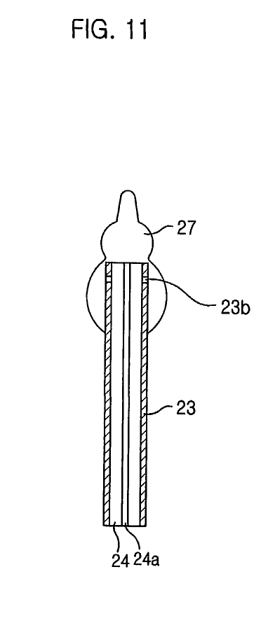

As shown in FIG. 11, the liniment absorption pad 25 can be molded in multi-steps, each step with different diameter so as to fit to the average diameter of the ear of children or adults. This way, inflammation inside the ear of a pet or a human being can be treated, safely by protecting the eardrum or mid-ear from being hurt while cleaning it. The present embodiment represents a structure in which the liniment absorption pad is molded in three steps. With a number of ejection holes 23B on an external surface of one end of the liniment inducing pipe 23, the liquid material is sent out and absorbed to the liniment absorption pad 27 faster.

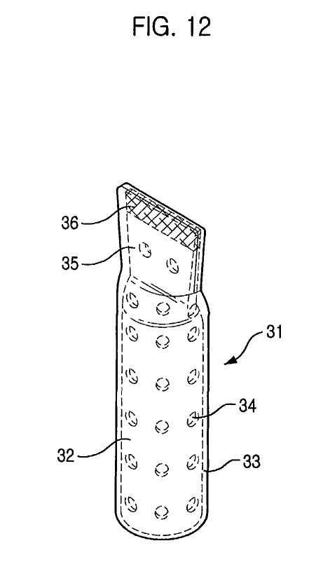

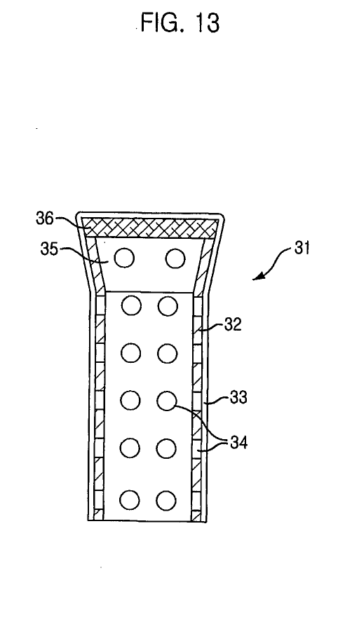

FIG. 12 represents a perspective view of a clean pad in accordance with another embodiment of the present invention, and FIG. 13 is the cross-sectional figure of it.

The reference numerals 31, 32 and 33 denote a clean pad, liniment inducing pipe and liniment absorption pad, respectively.

As illustrated in FIGS. 12 and 13, the clean pad 31 for absorbing the liquid provided from outside and applying it on a certain part of a body is composed of a liniment inducing pipe 32 and a liniment absorption pad 33.

For the liniment inducing pipe 32, used is a specially coated paper material that doesn't absorb water and perform the heat-sealing job smoothly. For instance, vinyl acetate ethylene copolymer water emulsion may be used. The coated paper material has pores at a regular interval. This is to promote the absorption of the liniment provided to the clean pad 31, which consists of the liniment inducing pipe 32 and the liniment absorption pad 33, towards the outside. The coated paper material with pores thereon is shaped into a cylinder with a predetermined external circumference, and then sanitary cotton is wrapped on the external surface. The wrapping cotton functions as a liniment absorption pad 33.

An adhesive material is used to attach the cotton to the paper material. The adhesive material is the same as what has been used to attach the liniment inducing pipe and the liniment absorption pad in FIG. 3. Likewise, a hardening agent or catalyst may be used to control the hardness of the liniment absorption pad and a germicidal agent or antibiotic material can be added in to produce a hygienic clean pad 31.

Heat-compressing one end of the cylindrical pipe made of the paper material and the cotton attached to each other, the both internal surfaces of the paper material get attached to each other as well as the external surface of the paper material to the cotton thereon, thus forming a flat surface 35 on the completed clean pad 31. Especially, a predetermined part 36 of the flat surface 35 is compressed with heat by using supersonic wave. This makes firm the adhesiveness between the paper materials, protecting the liniment from leaking through the one end of 30 the clean pad 31.

Meanwhile, in the present embodiment, to enhance the brushing function when applying the liniment injected to the clean pad, the flat surface 35 of the clean pad 31 can be embossed (not shown).

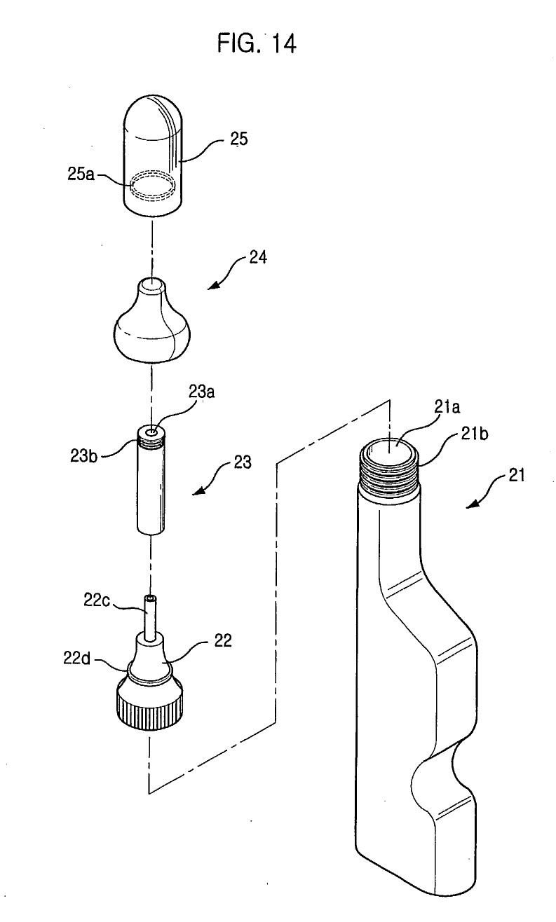

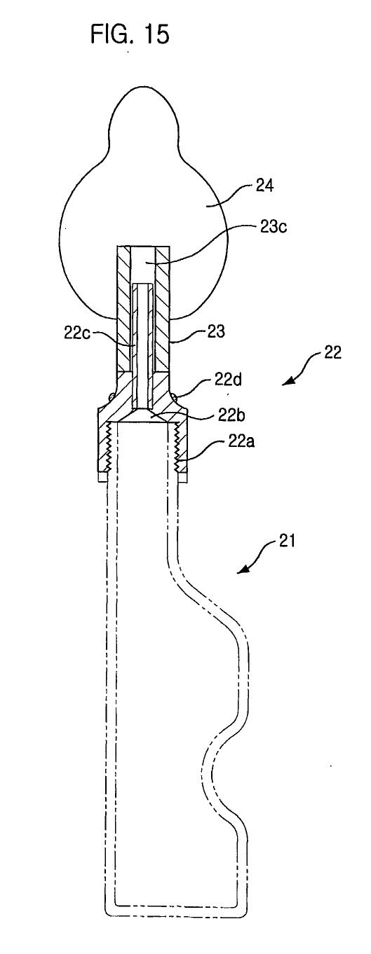

FIG. 14 is a perspective view illustrating a disassembled liniment spreading apparatus in accordance with yet another embodiment of the present invention, and FIG. 15 is a cross-sectional view of the assembled liniment spreading apparatus of FIG. 14.

To describe more in detail referring to FIGS. 14 and 15, the liniment spreading apparatus of yet another embodiment of the present invention comprises: a container 21 for containing the liquid material; a liniment inducing pipe 23 with a pipeline penetrating along the length for providing a flow path to the liniment; a liniment absorption pad 24, which is linked to the liniment inducing pipe 23, for absorbing the liniment and applying it on a certain part of a body; a joint block 22 for connecting the container and the liniment inducing pipe; and a cover 25 for closing the opening of the container when the liniment inducing pipe and the liniment absorption pad are removed. The liniment inducing pipe and the liniment absorption pad can be made of a disposable material.

The container for holding in the liquid material is molded with a male screw part 21B on the external circumferential surface at the opening 21A and contains a disinfectant or mucous liniment. In this case, the container is molded in a form to pick out a hole easily so as to perform a job like cleaning the ear.

The joint block 22 is provided with: a female screw part 22A on the internal circumferential surface of one end corresponding to the male screw part 21B of the container 21 to be linked; a penetrating hole 22B formed inside at the center for discharging the liniment from the opening 21A of the container 21; and a metallic pipe 22C that shapes like an injection needle of a predetermined size for ejecting the liniment at one end. The metallic pipe 22C is inserted to the pipeline 23A of the liniment inducing pipe 23 for the liquid to be injected easily. Here the diameter of the pipeline 23A is determined by that of the metallic pipe which will be inserted thereto firmly. The metallic pipe 22C is made of stainless steel.

The liniment inducing pipe 23 shapes like a pipeline 23A penetrating along the length to provide a flow path to the liniment and it is connected to the metallic pipe 23 of the joint block 22. The liniment inducing pipe 23 may be formed in a structure having at least one groove 23B or embossing along the external circumferential surface at one end. This is to make firm the wrapped liniment absorption pad 24.

The liniment absorption pad 24 wraps the embossed part 23B of the liniment inducing pipe 23, sticks to it with an adhesive material, absorbs the liniment discharged through the pipeline 23A of the liniment inducing pipe 23 and applies it to a certain part of a body. In the present invention, particularly, the liniment absorption pad 25 is molded in multi-steps, each step with different diameter so as to fit to the average diameter of the ear of children or adults. This way, inflammation inside the ear of a pet or a human being can be treated, safely by protecting the eardrum or mid-ear from being hurt while cleaning it.

The description on the cover 25 will. be omitted as it can be embodied the same as the cover 5 represented in FIG. 1.

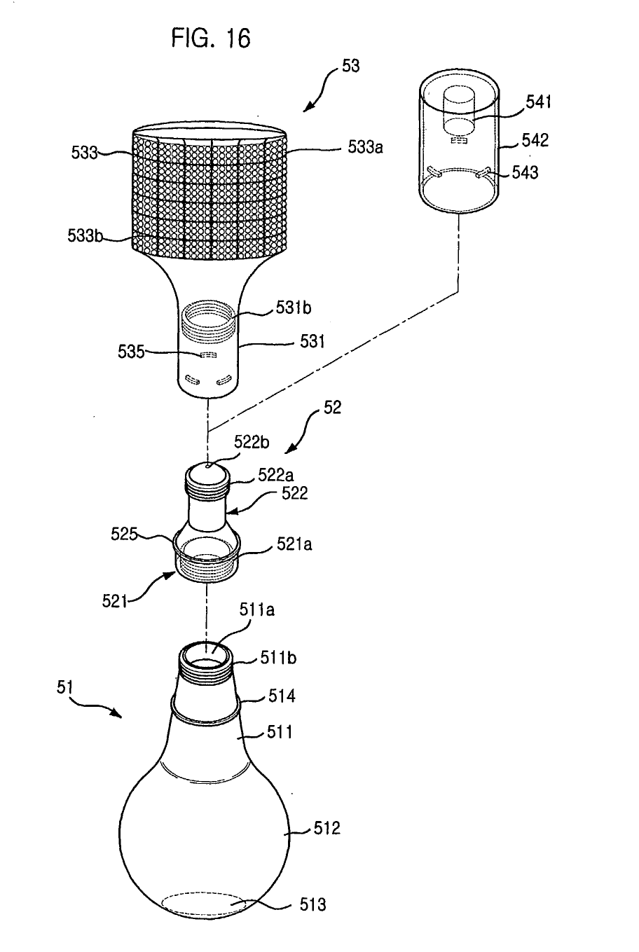

FIG. 16 is a disassembled perspective view depicting an order cleaner in accordance with an embodiment of the present invention.

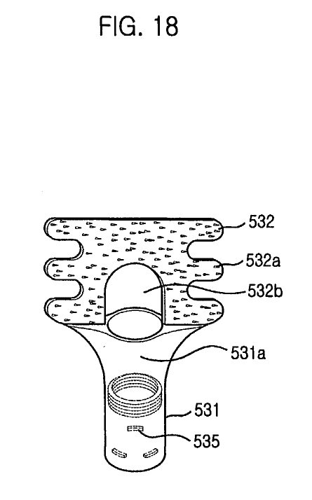

FIG. 18 is a perspective view of the clean pad without the absorption pad in accordance with the invention.

To refer to FIGS. 16 and 18 and describe, the container 51 consists of an opening 511A; a neck part 511 molded with a third male screw part 511B on the external circumferential surface of the upper part; a containing part 512, which is extended from the neck part 511, formed bulgy to increase the capacity for the liquid material and made of a soft plastic to discharge the liquid inside by being squeezed with hands; and a support part 513 formed at the bottom surface of the container for standing upright. Here the neck part 511 and the support part 513 are made of a hard plastic but this invention is not limited to it but soft plastic material can be used for the neck part 511 and the containing part 513 alike. The container 51 of the present embodiment for fulfilling the above conditions is mixed in the soft plastics and hard plastics ratio of 60%:40% ±5%.

The joint block 52 mediating the container 51 and the clean pad 53 can be divided into the connection part 521 and the provision pipe part 522. A third female screw part 521A is formed in the connection part 521 for being connected to a third male screw part 511B at the neck part 511 of the container 51. And the provision pipe lie 522 is molded in a predetermined length to discharge the liquid material easily. It is provided with a fourth male screw part 522A on the external circumferential surface and a fine hole 522B on the top to discharge the gargling solution from the opening of the container 51 at a little amount.

This embodiment forms the diameter of the fine hole 522B 0.5 mm˜0.8 mm±0.2 m wide so that the gargling solution should come out little by little.

As illustrated, the clean pad includes a gargling solution inducing pipe 531, which is formed in a predetermined length to induce the gargling solution coming out from the fine hole 522B of the joint block 52 and provided with a fourth female screw part 531B on the upper part of the internal circumferential surface to be coupled to the fourth male screw part 522A of the joint block 52 and an undercut 535 at the lower part of the internal circumferential surface and the ejection end part 531A of which is expanded in a predetermined width; a brush board 532, which is formed across the center of the ejection end part of the gargling solution inducing pipe 531 and provided with a plurality of thorns 532A on the external circumferential surface and a central inducing grooves 532B inside at the center for inducing the gargling solution; and an absorption pad 533, which wraps the external circumferential surface and attaches to external circumferential surface of the brush board 532 with an adhesive material, absorbs the liquid provided from the gargling solution inducing pipe 531 and maintains the wet status.

In the present embodiment, the absorption pad 533 is made of cotton to absorb the gargling solution sufficiently. Forming a rib on the upper part of the ejection part 531A of the gargling solution inducing pipe 531, this embodiment makes the brush board 532 connected to the gargling solution inducing pipe 531 firmly during the injection molding. With a structure connecting the ejection end part 531A to the central induction grooves 532B of the brush board 532, the gargling solution provided through the gargling solution inducing pipe 531 is made to reach the absorption fad 533 wrapping the brush board 532. However, forming the central induction groove 532B of the brush board 532 is a matter of function to be formed on one's choice. It needs not be formed in this structure but a brush board 532 without the groove 532B may be formed across the gargling solution inducing pipe 531. The method for manufacturing the clean pad 53 with above structure is as followings. First, the brush board 532 is injection-molded to be integrated to the ejection end part of the gargling solution inducing pipe 531 in diametric direction; and the absorption pad 533 is wrapped to the brush board 532 in several folds. Here the absorption pad 533 is wrapped to it with an adhesive material unharmful to a human body such as CMC (Carboxyl Methyl Cellulose), EVA (Ethylene-Vinyl Acetate Copolymer), melamine, gelatin, polyethylene, hydro-propyl cellulose, ethylene acid bicopolymer and dextrin, so that the absorption pad 533 does not get removed from the brush board 532 easily. After the procedure, the absorption pad 533 is thermally compressed by pressing both sides of the brush board 532 with a heat-compressor (not shown) at 120°˜280° C. to maintain a predetermined hardness. Subsequently, the air inside the absorption pad 533 folded in many layers comes out and the thickness gets a third or a half thinner according to the compression strength. Then, going through the procedure of ultraviolet ray or ozone sterilization, the clean pad 53 is manufactured finally.

Here, the thorns 532A of the brush board 532 and the absorption pad 833 being adhered closely and embossed in a predetermined size, a flat brush is made up and substitutes a toothbrush. The undescribed reference number 533B represents the thermal compression line formed when compressing the absorption pad 533 with heat.

In the manufacturing procedures, in case that the embossing 533A is formed soft on the absorption pad 533, the heat-compression line needs to be formed by selecting a method either spraying or coating the adhesive material on the surface of the embossing 533A, heating after controlling the thickness of the adhesive material and applying it, and hardening the adhesive material together with the absorption pad. Then the embossed surface does not get rubbed off easily and clears the teeth effectively when brushing the teeth.

The clean pad 53 is made for disposable use. Here the materials represented in FIG. 3 of the aforementioned embodiment are used for making the brush board 532 and the gargling solution inducing pipe 531. Decomposed easily, the clean pad 53 will cope with the environmental problem appropriately.

The brush board 532 and the gargling solution inducing pipe 531 should maintain a predetermined hardness to make the liquid flow smoothly keeping the brush board 532 as the core part. Considering the point, this embodiment forms the brush board 532 and the gargling solution inducing pipe 531 with gelatin thickness 220˜280 bloom hard. Besides, when using a clean pad made of collagen in substitution of plastics except gelatin used for the brush board 532 and the gargling solution inducing pipe 531, it is more suitable than general plastics in the hardness and molding aspects.

In the mean time, the present invention is provided with a cover 542, one end of which is inserted to. the container 51, the other end of which is formed with a suture pipe 541 for stitching the hole 522B of the joint block 52 inside and which protects the joint block 52 while the clean pad 53 is removed.

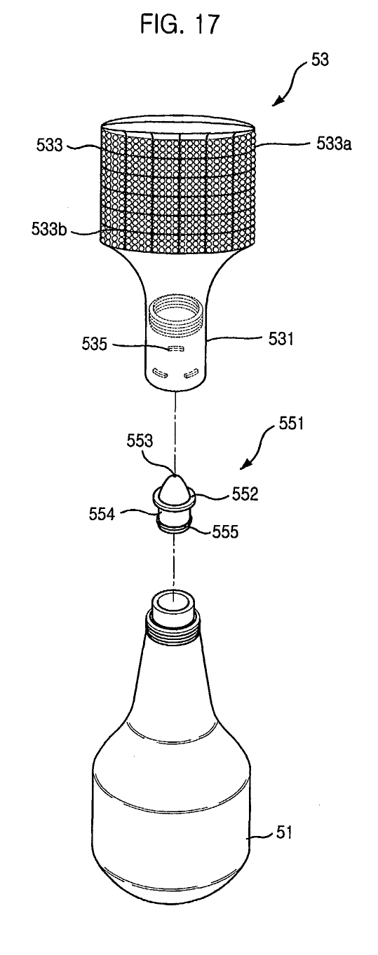

FIG. 17 is a disassembled perspective view showing an order cleaner in accordance with another embodiment of the present invention. It illustrates a portable oral cleaner. As shown in the drawing, its container 51 is made the same as that of the aforementioned embodiment and the same reference numerals are used for the same constituents as those of the embodiment described previously.

The present embodiment suggests a structure where the clean pad 53 is attached directly to the container 51. In other words, on the opening of the container 81 is formed a cork 551 for preventing any leakage of the gargling solution inside, and on the external circumferential surface of the opening of the container 51, the clean pad 53 is attached with screws, undercuts or in the method of insert-and-fix. Here, the cork 551 is provided with a threshold, which is formed at the external circumferential surface of the container, for preventing further insertion towards the inside of the container by being stuck; a cork body with a fine hole 553 at the center of the upper part for sending out the liquid; and a packing 555 at the external circumferential surface of the lower part for sealing up the opening of the container tightly. The clean pad 53 is also the same as that of the previous embodiment.

While the present invention has been described with respect to certain preferred embodiments, it will be apparent to those skilled in the art that various changes and modifications may be made without departing from the scope of the invention as defined in the following claims.

1. A liniment spreading apparatus, comprising:
a liniment provision means;
a liniment inducing means linked to the liniment provision means, for providing a flow path of a liniment; and
a liniment absorption means, which is wrapping one end of the liniment inducing means, for absorbing the liniment discharged therefrom and applying it to a certain part of a body.

2. The apparatus as recited in claim 1, further comprising a cover to be laid on one end of the liniment provision means.

3. The apparatus as recited in claim 1, wherein the liniment provision means includes:
a container for containing the liniment; and
a liniment mid-provision means coupled to the opening of the container, for continuing to provide the liniment coming out therefrom at a predetermined amount.

4. The apparatus as recited in claim 1, wherein material for the liniment inducing means is one among plastics, gelatin, flour, starch, condorax and paper material.

5. The apparatus as recited in claim 1, wherein adhesive material for putting the liniment absorption means to the liniment inducing means are one among CMC (Carboxyl Methyl Cellulose), EVA (Ethylene-Vinyl Acetate Copolymer), melamine, gelatin, hydro-propyl cellulose, ethylene acid bicopolymer and dextrin.

6. The apparatus as recited in claim 1, wherein one end of the liniment inducing means has a plurality of thorn-shaped fixed protrusions on the external circumferential surface to fix the liniment absorption means thereon firmly.

7. The apparatus as recited in claim 6, wherein one end of the liniment inducing means has a plurality of ejection holes on the external circumferential surface to discharge the liniment in a predetermined amount.

8. The apparatus as recited in claim 1, wherein the liniment absorption means is made of cotton.

9. The apparatus as recited in claim 2, wherein the cover has an undercut, which is molded on its internal circumferential surface of the lower part and corresponds to the underline on the neck part of the container to be combined in the method of insert-and-fix.

10. The apparatus as recited in claim 3, wherein the container includes a first male screw formed on the external circumferential surface of the neck part and an underline formed on the external circumferential surface of the lower part, while the liniment mid-provision means has a first female screw on its internal circumferential surface to be coupled to the first male screw, and a second male screw molded on the external circumferential surface of the upper part to be coupled to the second female screw of the liniment inducing means.

11. The apparatus as recited in claim 3, wherein the liniment mid-provision means further includes a metallic pipe of a predetermined size which being placed on one end of it, discharges the liniment.

12. The apparatus as recited in claim 1, wherein the liniment inducing means has a shape of a pipeline penetrating in the direction of length.

13. The apparatus as recited in claim 1, wherein a plurality of guiding grooves are molded in the direction of length on the internal circumferential surface of the pipeline of the liniment inducing means.

14. The apparatus as recited in claim 13, wherein at least one ejection hole is molded on the external circumferential surface of one end of the liniment inducing means for sending out the liniment.

15. The apparatus as recited in claim 12, wherein the liniment absorption means is formed of cotton compressed and hardened as much as a predetermined width of its external circumference.

16. The apparatus as recited in claim 15, wherein the hardened surface of the liniment absorption means is embossed.

17. The apparatus as recited in claim 12, wherein the liniment absorption means is molded in multi-steps each having a different diameter.

18. The apparatus as recited in claim 13, wherein the liniment provision means includes:
a liniment mid-provision means which has a plurality of protrusions on the external circumferential surface corresponding to guiding grooves so as to be inserted to the guiding grooves of the liniment inducing means and get fixed and a midway hole connected to the pipeline; and
a container combined to one end of the liniment mid-provision means.

19. The apparatus as recited in claim 12, wherein the liniment inducing means has a predetermined size of a plane surface which is formed by cutting one end of the liniment inducing means in the length direction, and has a plurality of thorn-shaped protrusions thereon.

20. The apparatus as recited in claim 18, wherein the liniment inducing means further includes a plurality of ejection holes between thorn-shape fixed protrusions.

21. The apparatus as recited in claim 19, wherein the liniment provision means includes:
a liniment mid-provision means provided with a first female screw on the internal circumferential surface of one end and a second female screw on the other end, corresponding to a male screw on the external circumferential surface of the liniment inducing means; and
a container provided with a male screw on the external circumferential surface of an opening, corresponding to the second female screw of the liniment mid-provision means.

22. The apparatus as recited in claim 21, wherein with an underline molded on one end of the liniment mid-provision means or the liniment inducing means and an undercut molded on the other corresponding to the underline, the liniment mid-provision means and the liniment inducing means are connected in an insert-and-fix method.

23. The apparatus as recited in claim 19, wherein the liniment absorption means, of which a predetermined part is made of cotton compressed and hardened.

24. The apparatus as recited in claim 23, wherein the hardened surface of the liniment absorption means is embossed.

25. The apparatus as recited in claim 24, wherein the liniment absorption means is molded in multi-steps, each with different diameter.

26. The apparatus as recited in claim 1, wherein the liniment inducing means includes:
a liniment inducing pipe having a predetermined length for inducing the liniment discharged from the liniment provision means, the ejection part of the liniment inducing pipe being expanded to a predetermined size; and
a brush board formed on the ejection part of the liniment inducing pipe, having a plurality of thorns molded on the external circumferential surface.

27. The apparatus as recited in claim 26, wherein the liniment inducing means further includes a central induction groove which is formed on the central part of the brush board, and being connected to the ejection part of the liniment inducing pipe, such that makes the liniment is reached to the liniment absorption means fast.

28. The apparatus as recited in claim 26, wherein the brush board is formed across the central line of the ejection part of the liniment inducing pipe.

29. The apparatus as recited in claim 26, wherein the liniment absorption means is made of cotton of which a predetermined part is compressed and hardened.

30. The apparatus as recited in claim 29, wherein the hardened surface of the liniment absorption means is embossed.

31. The apparatus as recited in claim 26, wherein the liniment provision means includes:
a liniment mid-provision means provided with a first male screw part on the external circumferential surface of one end and a first female screw on the other part, corresponding to the female screw on the internal circumferential surface of the other end of the liniment inducing means; and
a container provided with a second male screw part on the external circumferential surface of the opening, corresponding to the first female screw on the other end part of the liniment mid-provision means.

32. The apparatus as recited in claim 26, wherein the liniment provision means including;
a container for containing the liniment;
a cork body which is molded with a threshold for preventing further insertion towards the inside of the container by its external circumference being stuck at the opening of container, and with a fine hole formed at the center of the upper part for sending out the liquid; and
a sealing means which is formed on the external circumferential surface of the lower part of the cork body for sealing up the opening of the container tightly.
